(19) United States
(12) Patent Application Publication
(10) Pub. No.: US 2007/0081353 A1
(43) Pub. Date: Apr. 12, 2007

(54) Rear lighting assembly for motor vehicles

(75) Inventors: Frank Gutjahr, Wendlingen (DE); Thorsten Fink, Albershausen (DE)

Correspondence Address: CLARK HILL, P.C., 500 WOODWARD AVENUE, SUITE 3500, DETROIT, MI, 48226, US

(73) Assignee: Schefenacker Vision Systems Germany GmbH, Schwaikheim (DE)

(21) Appl. No.: 11/546,192

(22) Filed: Oct. 11, 2006

(30) Foreign Application Priority Data
Oct. 11, 2005 (DE) 10 2005 050 011.0

(51) Int. Cl. F21V 1/00

(52) U.S. Cl. 362/509

(57) ABSTRACT

Lighting unit, preferably rear light, for vehicles, preferably motor vehicles The lighting unit has a housing (1), in which at least one lamp (2, 3) is housed, which lies behind a lens (4). Furthermore, the lighting unit has at least one electroluminescent layer (12 through 15). In order that the lighting unit may be produced cost-effectively in such a way that a desired, particularly homogeneous light distribution is reliably achieved, the electroluminescent layer (12 through 15) is provided on the lens (4). The components (5, 6) required for the lamps (2, 3) in the housing (1), such as reflectors, may thus be used without restriction. The electroluminescent layer (12 through 15) may be situated without problems on the lens (4). The lighting unit is preferably a rear light for motor vehicles.

The present invention relates to a lighting unit, preferably a rear light, for vehicles, preferably for motor vehicles, according to the preamble of Claims 1 and/or 10.

In lighting units, such as rear lights of motor vehicles, incandescent bulbs and/or LED's are used as lamps. Homogeneous light may not be generated using these lamps, since the lamps are point radiators. In order to achieve better homogeneous light distribution, optical fibers are known, into which light is introduced laterally using LED's. The light is conducted in the optical fiber up to an outlet point. Entirely homogeneous light distribution may only approximately be achieved using such optical fibers.

Furthermore, providing electroluminescent layers in addition to these lamps in the lighting unit is known. These layers are provided on the reflector for the incandescent lamps or on lens holders. The production of such lighting units is complex, however, particularly if the electroluminescent layer is provided on the reflector. Since the light emitted by the incandescent lamp is to be reflected as completely as possible toward the lens using the reflector, the electroluminescent layers must be implemented as partially transparent, so that the part of the reflector covered by the electroluminescent layers may also be used for reflecting the incandescent lamp radiation.

The present invention is based on the object of implementing the lighting unit according to the species in such a way that it may be produced cost-effectively so that a desired, particularly homogeneous light distribution is reliably achieved.

This object is achieved according to the present invention in the lighting unit according to the species by the characterizing features of Claim 1 and/or 10.

In the lighting unit according to Claim 1, the electroluminescent layer is provided on the lens. The components required for the lamp in the housing, such as reflectors, may thus be used without restriction. The electroluminescent layer may be situated without problems on the lens, so that the lighting unit according to the present invention may be produced easily and cost-effectively.

In the lighting unit according to Claim 10, the electroluminescent layer is back molded. In this case, the inverter required for operating the electroluminescent layer may advantageously be housed in the back-molded area, and is embedded in this area and thus optimally protected.

Through the combination of the standard lamp for fulfilling the legal requirements and the electroluminescent layer, a large-area homogeneous light may be achieved. Depending on the type of the electroluminescent layer, desired light effects may be implemented, so that the light manufacturer has the possibility, for example, of achieving different effects in his lighting units as a differentiation feature in the meaning of a corporate identity, for example, depending on the car type, for example. The light yield is also elevated by the use of the lamps and the electroluminescent layer which is provided on the lens itself.

Further features of the present invention result from the further claims, the description, and the drawing.

The present invention is explained in greater detail on the basis of several embodiments illustrated in the drawing.

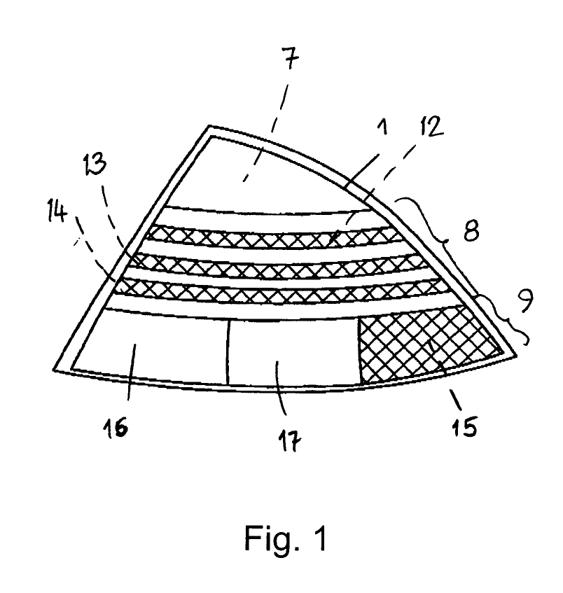

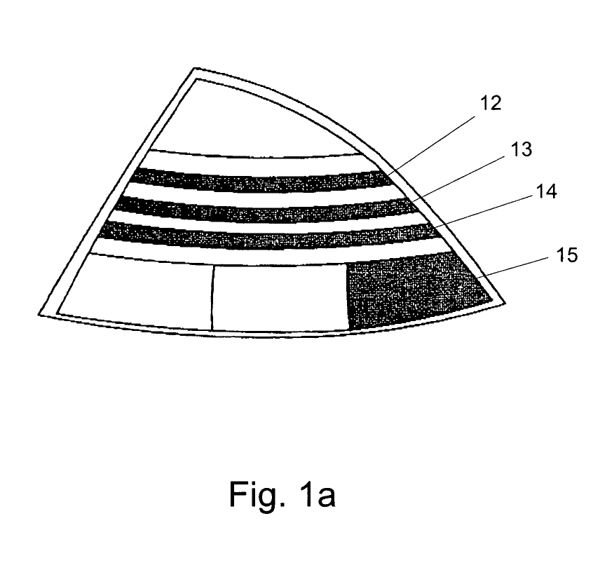

FIG. 1 shows a lighting unit according to the present invention in a top view and in the unlighted state,

FIG. 1a shows the lighting unit from FIG. 1 in the lighted state,

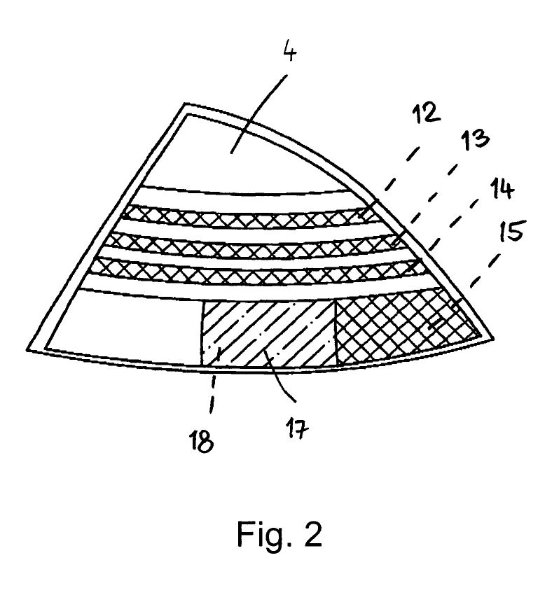

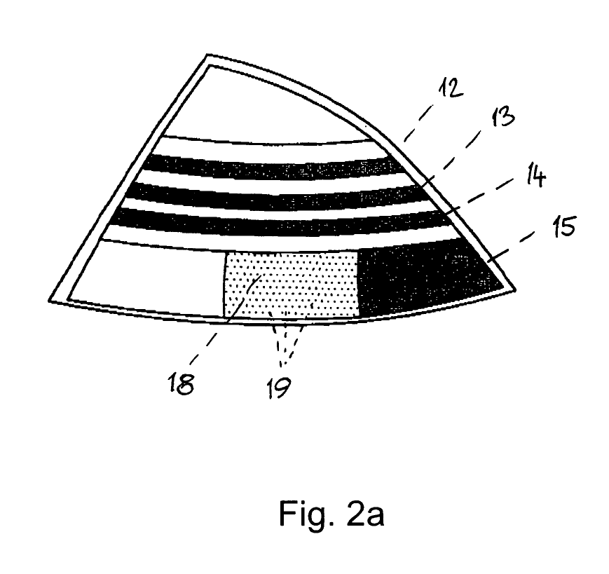

FIG. 2 shows a second embodiment of a lighting unit according to the present invention in the unlighted state in an illustration corresponding to FIG. 1,

FIG. 2a shows the lighting unit from FIG. 2 in the lighted state,

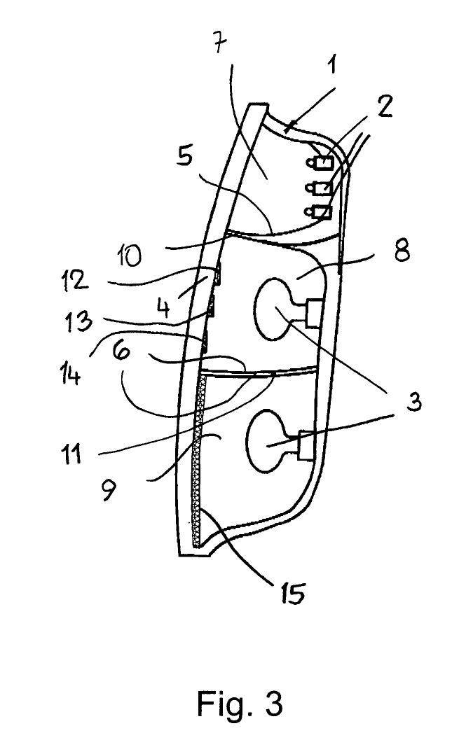

FIG. 3 shows a schematic illustration of a section through the lighting unit according to the present invention from FIG. 1,

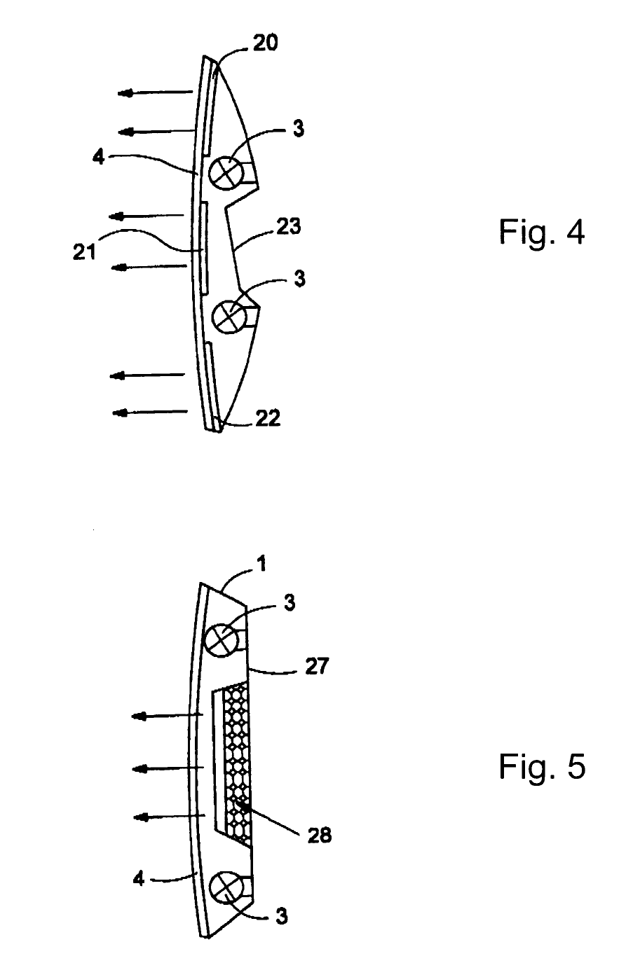

FIG. 4 and

FIG. 5 each show a section through further embodiments of lighting units according to the present invention.

The lighting units are rear lights in the exemplary embodiment, which are advantageously used in motor vehicles. However, they may also be used for other lamp vehicles, of course. The rear light shown in FIGS. 1 and 1a has a housing 1, in which lamps 2, 3 are housed (FIG. 3). The lamps 2 are LED's, while the lamps 3 are formed by incandescent lamps. These lamps 2, 3 are only indicated as examples. For example, halogen lights, xenon lights, and the like may also be used as lamps. Two different types of lamps 2, 3 are housed in the housing 1 as an example in FIG. 3. Of course, it is also possible to only use one type of lamp in the housing 1.

The housing 1 is closed at the light exit side by a lens 4, behind which the lamps 2, 3 are located at an interval. The lamps 2, 3 may have reflectors 5, 6 assigned to them, which reflect the light emitted by the lamps 2, 3 in the direction toward the lens 4.

In the embodiment shown in FIGS. 1, 1a, the housing 1 has an approximately triangular outline. Depending on the type of vehicle in which the rear light is to be used, the housing 1 may also have a different outline, for example, a rectangular outline. The interior of the housing 1 is divided in the embodiment shown in FIGS. 1, 1a, and 3 into chambers 7 through 9, which are situated one on top of another. The lamps 2, which are situated one on top of another, for example, are housed in the upper chamber 7. In the chamber 7, the lamps 2 may be situated not only one on top of another, but rather also neighboring one another. The lamps 2 may also be situated uniformly distributed on the rear wall of the chamber 7.

The middle chamber 8 is separated by a partition wall 10 from the upper chamber 7 and by a partition wall 11 from the lower chamber 9. Strip-shaped electroluminescent films 12 through 14 are attached to the interior of the lens 4 at intervals one on top of another inside the chamber 8. As shown, they may have equal widths, but may also have different widths depending on the desired usage and intended purpose of the rear light. The electroluminescent films 12 through 14 extend over the entire width of the chamber 8 between diametrically opposite edges of the housing 1.

A further electroluminescent film 15 is attached in the lower chamber 9 to the interior of the lens 4 in the corner area, which extends over the height of the chamber 9 (FIG. 1) and has a length which corresponds to approximately a third of the length of the chamber 9. The electroluminescent film 15 has a polygonal outline and extends outward from the right lower corner area of the lens 4 in FIG. 1.

The electroluminescent films 12 through 15 each generate a homogeneous light over their area, while the lamps 2, 3 emit the light punctually. Through the combination of these different lamps 2, 3 and 12 through 15, the legal requirements in regard to the luminous intensity of the rear light are fulfilled, and, in addition, a planar light radiation is achieved. By using the electroluminescent films 12 through 15, the rear light may be equipped with a desired light design to differentiate different vehicle types from one another through different design shapes of the rear light. The electroluminescent films may be implemented differently to achieve a fluorescence or glitter effect, for example. The electroluminescent films required for such effects are known and therefore will not be explained in greater detail.

It is advantageous if the electroluminescent films 12 through 15 may be turned on and off independently of the lamps 2, 3. The electroluminescent films 12 through 15 may also be produced in different light colors, so that, for example, the electroluminescent films 12 through 14 may emit light in a different color tone than the electroluminescent film 15. In addition, the electroluminescent films 12 through 15 may be designed so that in the turned-off state they have a specific incident light color, which is recognizable through the lens 4 of the rear light.

The lamps 3 in the middle chamber 8 emit their light outward through the lens 4 in the area between the strip-shaped electroluminescent films 12 through 14. As FIG. 3 shows, the lamp 3 is located centrally behind the electroluminescent films 12 to 14.

The lamps 3 in the lower chamber 4 are situated so that the majority of the light emitted by them is emitted outward through the lens 4 past the electroluminescent film 15. As shown in FIG. 1, the lens 4 is divided in the area of the lower chamber 9 into three approximately equally large light areas 16, 17, 18, to which different signal functions of the rear light may be assigned.

FIG. 1 shows the rear light in the unpowered state. The strip-shaped electroluminescent films 12 through 14 and the rectangular electroluminescent film 15 may be recognized through the lens 4. Their incident light color, which they have in the turned-off state, may be set by the designer of the rear light to achieve a desired design of the rear light.

If the rear light is powered, the electroluminescent films 12 through 15 illuminate in the particular color tone (FIG. 1a). The rear light thus obtains a particular appearance. Since the electroluminescent films 12 through 15 may advantageously be turned on independently of the lamps 2, 3, the illuminated state shown in FIG. 1a may be achieved solely by turning on the electroluminescent films 12 through 15.

FIGS. 2, 2a show an embodiment in which an electroluminescent film 18 is also provided in the lens area 17 on the interior of the lens 4. Otherwise, the rear light is implemented identically to the prior exemplary embodiment. FIG. 2 shows the rear light in the unpowered state. The strip-shaped electroluminescent films 12 through 14 and the electroluminescent films 15 and 18 located in the lower area are recognizable through the lens 4. The electroluminescent film 18 has an approximately rectangular outline. If the films are unpowered, they may be recognized through the lens 4 in their particular incident light color. However, if the electroluminescent films 12 through 15, 18 are powered, an appearance corresponding to FIG. 2a results. The electroluminescent film 18 is implemented for this purpose so that the light is not emitted in a planar way as in the electroluminescent films 12 through 15, but rather in matrix dots 19.

The electroluminescent films 12 through 15, 18 may also be integrated in the lens 4, through which an optimum protection of the electroluminescent films is achieved.

In the embodiment shown in FIG. 4, electroluminescent films 20 through 22 are seated on the interior of the lens 4 at intervals one on top of another. The lamps 3, which are attached to carrier 23, are located in the area between neighboring electroluminescent films. The light emitted by the lamps 3 radiates outward through the lens 4 in the area between neighboring electroluminescent films 20 through 22. The electroluminescent films 20 through 22 may have any shape, for example, they may extend over the width of the rear light.

FIG. 5 shows an exemplary embodiment in which the electroluminescent film 26 is situated at an interval behind the lens 4. In addition, the electroluminescent film 26 lies between lamps 3 which are situated at an interval above and below the electroluminescent film 26 in the housing 1. The electroluminescent film 26 is back molded and held on the interior of the floor 27 of the housing 1. The extrusion-coated area 28 may contain a circuit board, for example, to which both the electroluminescent film 26 and also the lamps 3 are connected. This circuit board lies protected inside the extrusion coating. Reflectors may be provided for the lamps 3 in the housing 1, which reflect the light emitted by the lamps toward the lens 4.

The inverter required for operating the electroluminescent film 26 is advantageously provided on the circuit board required for the lamps 3. The possibility thus exists of producing homogeneous contours and planar areas on the rear light with extremely tight overall space.

In all embodiments, effects, such as fluorescence or glitter effects, may be set by combination with pigments, and the light yield may be amplified and additional light effects may be implemented.

1. A lighting unit, preferably a rear light, for vehicles, preferably motor vehicles, having a housing in which at least one lamp is housed, which lies behind a lens, and having at least one electroluminescent layer, characterized in that the electroluminescent layer (12 through 15, 18, 20 through 22) is provided on the lens (4).

2. The lighting unit according to claim 1, characterized in that the electroluminescent layer (12 through 15, 18, 20 through 22) is attached to the interior of the lens (4).

3. The lighting unit according to claim 2, characterized in that the electroluminescent layer (12 through 15, 18, 20 through 22) is integrated in the lens (4).

4. The lighting unit according to claim 3, characterized in that the electroluminescent layer (12 through 14) has a strip shape.

5. The lighting unit according to claim 4, characterized in that multiple electroluminescent layers (12 through 14, 20 through 22) lie one on top of another at intervals.

6. The lighting unit according to claim 5, characterized in that the lamps (2, 3) are situated in the area between electroluminescent layers (12 through 14, 20 through 22).

7. The lighting unit according to claim 6, characterized in that the electroluminescent layer (15) is implemented as a rectangular planar element.

8. The lighting unit according to claim 7, characterized in that the electroluminescent layer (12 through 15, 20 through 22) illuminates in a planar way in the turned on state.

9. The lighting unit according to claim 8, characterized in that the electroluminescent layer (18) illuminates in the form of a dot matrix in the turned on state.

10. A lighting unit, particularly according to claim 9, characterized in that the electroluminescent layer (26) is back molded.

11. The lighting unit according to claim 10, characterized in that a circuit board for the electroluminescent layer (26) and the lamps (2, 3) is housed in the back-molded area (28).

12. The lighting unit according to claim 11, characterized in that an inverter for the electroluminescent layer (26) is seated on the circuit board.

13. The lighting unit according to claim 12, characterized in that the electroluminescent layer (26) is situated between neighboring lamps (2, 3).

14. The lighting unit according to 13, characterized in that the electroluminescent layer (12 through 15, 18, 20 through 22, 26) may be turned on and/or off independently of the lamps (2, 3).

15. The lighting unit according to claim 14, characterized in that the lamp (2) is an incandescent lamp.

16. The lighting unit according to claim 14, characterized in that the lamp (3) is an LED.
